(19) United States
(12) Patent Application Publication
(10) Pub. No.: US 2008/0014068 A1
(43) Pub. Date: Jan. 17, 2008

(54) APPARATUS FOR TRANSPORTING MULTIPLE ATVs IN A VEHICLE

(75) Inventor: James Smith, Martinsville, IL (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: RAK-N-ROL, LLC

(21) Appl. No.: 11/457,181

(22) Filed: Jul. 13, 2006

(51) Int. Cl. B60P 1/00

(52) U.S. Cl. 414/545

(57) ABSTRACT

An apparatus for transporting multiple off-highway vehicles in a bed of a pickup truck. The apparatus includes a pair of front uprights and a pair of rear uprights. A platform is pivotally attached to the front uprights and slidingly attached to the rear uprights. A cable is provided for pivotally raising and lowering the platform about its attachment to the front, such that a first ATV may be parked on the platform and a second ATV may be parked under the platform so that the pickup truck may transport two ATVs simultaneously.

### FIELD OF THE INVENTION

The invention relates to a device for transporting vehicles in a truck bed. More specifically, the invention relates to a device for transporting multiple all terrain vehicles and other off-highway vehicles in the bed of a standard sized pickup truck.

### BACKGROUND OF THE INVENTION

In the past, there has been difficulty for farmers, campers, hunters, all terrain vehicle (“ATV”) racers and other ATV enthusiasts wanting to transport multiple ATVs with a private vehicle, such as a pickup truck, without the use of a trailer. A standard pickup truck bed only provides enough space for a single ATV of the most common sizes. Trailers represent an additional expense to buy, maintain and license for an ATV user who wishes to transport multiple ATVs. Trailers also provide a difficulty when driving, particularly in parking and backing, and an extra hassle to hitch. Many states provide lower highway speed limits for vehicles with trailers.

A particular problem with transporting ATVs by trailer is that another vehicle and driver will be required if the person would like to tow a second trailer. For example, in the case of a hunter or camper, typically the person will desire to also tow a camping trailer or a boat and trailer. However, if a hunter or camper also wishes to transport two ATVs, the hunter or camper will require two vehicles that have been equipped to tow a trailer, one to tow the ATV trailer and one to tow the camper or boat, as well as a second driver. This is undesirable or, in some cases, not possible.

Therefore, it would be advantageous to provide a method to transport multiple ATVs in a bed of a pickup truck without the necessity to use a trailer.

Other attempts have been made to transport multiple ATVs in a single truck bed. However, for various reasons, these attempts have been unsatisfactory. For example, U.S. Pat. No. 4,874,284 discloses an apparatus for transporting two ATVs by loading them with ramps from the side of the truck bed. This is undesirable because the ramps must either be very long or at an extreme, and perhaps unsafe, incline in order to load the ATVs over the side of the truck bed. Additionally, the ramps will likely scratch the truck bed's paint on the exterior of the bed and/or the tops of the bed sides. The '284 patent's configuration leaves very little secure structure to which the ATVs may be attached to keep them securely in the bed. Finally, because both ATVs are raised above the truck bed floor, the center of gravity of the truck may be raised more significantly than the present invention.

U.S. Pat. No. 6,536,822 attempts to load ATVs in the truck bed by extending the truck bed with a ramp structure. The extended structure is supported by the vehicle's trailer hitch receiver. This arrangement precariously extends a large amount of weight off the end of the vehicle and will cause the vehicle to “squat” in the rear of the vehicle. Squatting will unduly negatively affect vehicle handling. However, most importantly, because the arrangement of the '822 patent uses the vehicle receiver to support the extending structure, a trailer cannot be towed. Therefore, in the instance of the '822 patent, a second tow vehicle will still be required in order to tow a camping trailer or a boat, thereby not achieving one of the objectives achieved by the present invention.

### SUMMARY OF THE INVENTION

The present invention comprises an apparatus for transporting multiple off-highway vehicles in a bed of a pickup truck. The apparatus includes a pair of front uprights and a pair of rear uprights. A platform is pivotally attached to the front uprights and slidingly attached to the rear uprights. A cable is provided for pivotally raising and lowering the platform about its attachment to the front, such that a first ATV may be parked on the platform and a second ATV may be parked under the platform so that the pickup truck may transport two ATVs simultaneously.

### BRIEF DESCRIPTION OF THE DRAWINGS

FIG. 1 is a perspective view of an apparatus according to an embodiment of the present invention in a first position;

FIG. 2 is a perspective view of an apparatus according to an embodiment of the present invention in a second position;

FIG. 3 is a perspective view of an apparatus according to an embodiment of the present invention in a third position;

FIG. 4 is a side view of an apparatus according to an embodiment of the present invention having a ATV mounted thereon;

FIG. 5 is a side view of an apparatus according to an embodiment of the present invention having a ATV mounted thereon and a second ATV being driven thereon; and

FIG. 6 is a side view of an apparatus according to an embodiment of the present invention having two ATVs mounted thereon.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention comprises an apparatus for transporting two off-highway vehicles capable of fitting within a standard truck bed. Off highway vehicles shall be defined as all terrain vehicles (“ATVs”) and snowmobiles. In the preferred embodiment illustrated, the apparatus is optimized for ATVs. However, one of ordinary skill in art would readily recognize how the preferred embodiment can be used for other vehicle types.

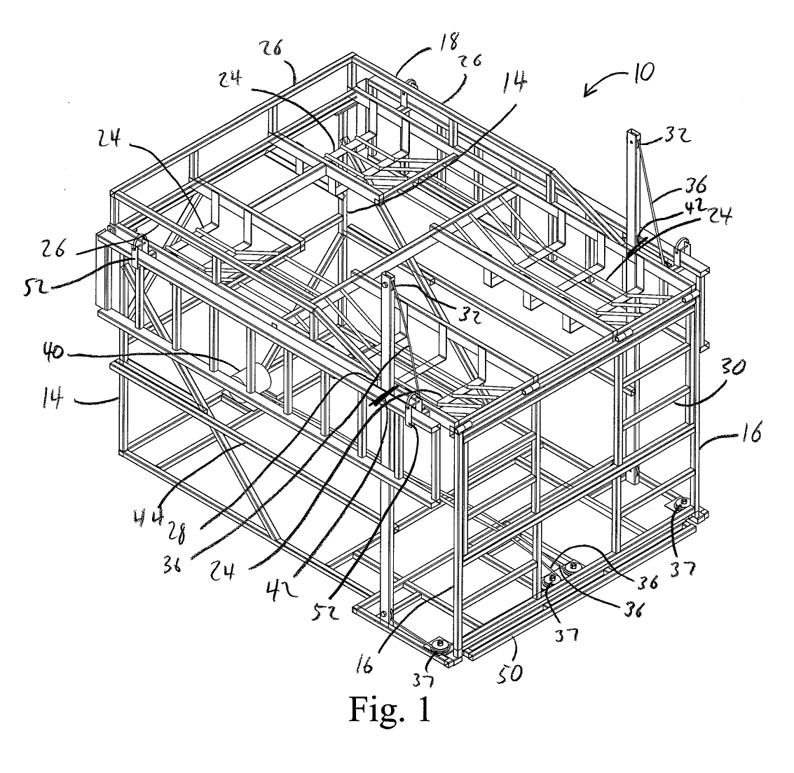

Referring to FIGS. 1-3, the apparatus of preferred embodiment of the present invention is shown and generally labeled 10. The apparatus 10 is mounted within a bed of a pickup truck. It will be understood by one of ordinary skill in the art that the preferred embodiment of the present invention could be modified to fit within different length pickup truck beds. The apparatus 10 generally comprises a pair of front uprights 14 and a pair of hollow rear uprights 16. Pivotally mounted to the front uprights 14 is a platform 18. A base structure 19 attaches all of the uprights 14 and 16 and is mounted to the bed of the truck with fasteners.

The platform 18 comprises lateral supports and longitudinal supports and preferably comprises four lowered portions 24 that correspond generally to the wheel positions of the ATV to be transported. The lowered portions 24 provide stability for the upper ATV, such that when the ATV is secured to the platform, the wheels of the ATV will not easily slide out of the lowered portions 24, such as in the case of an accident or very hard braking, turning or acceleration. Front and side rails 26 further provide assurance that a prudent and cautious ATV rider will not drive off the side or end of the platform 18 while loading or unloading the ATV.

The platform 18 is pivotally attached to the front uprights 14 by means of fasteners and is slidingly mounted to the rear uprights 16 by means of mounting blocks 28. The mounting blocks 28 are located about the rear uprights 16 such that the mounting blocks 28 can slide up and down along the length of the rear uprights 16 but are maintained in position laterally by the uprights 16. The attachment of the mounting blocks 28 to the platform 18 further accommodates for the change in distance of the mounting blocks 28 from the front uprights 14 as the platform 18 is raised and lowered.

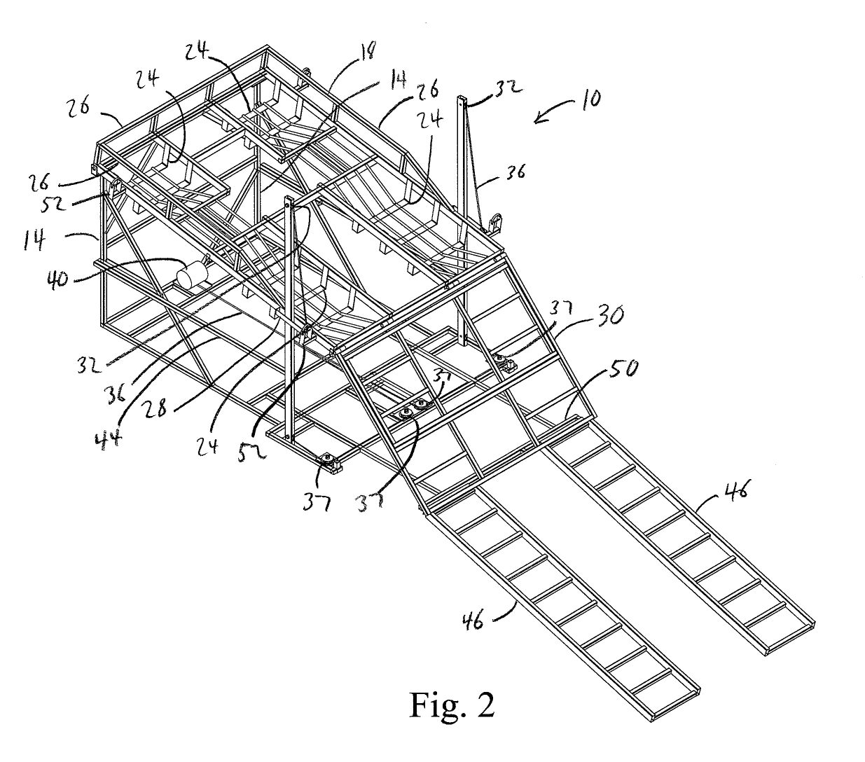

As can be seen with FIGS. 1 and 2, attached to a rear portion of the platform 18 is a ramp 30 portion. When the platform 18 is in a raised position, the ramp 30 hangs vertically.

An upper pulley 32 is mounted at the top of each rear upright 16, and a lower pulley 34 is mounted at the bottom of each rear upright 16. Attached to the platform 18 at a location rearward of the rear uprights 16 are two cables 36. The cables 36 each extend upwardly from the platform 18 and loop over the respective upper pulleys 32. The cables 36 next each extend through a respective hollow rear upright 16 and each loop over a lower pulley 34. Finally, the cables 36 extend around guide pulleys 37 to a winch 40. The winch 40 may be either an electric winch operating off the vehicle's power supply or a hand operated winch, as costs dictate. Pins 42 extend through the mounting blocks 28 and the rear uprights 16 when the platform is in a generally horizontal position to retain the platform 18 fixedly.

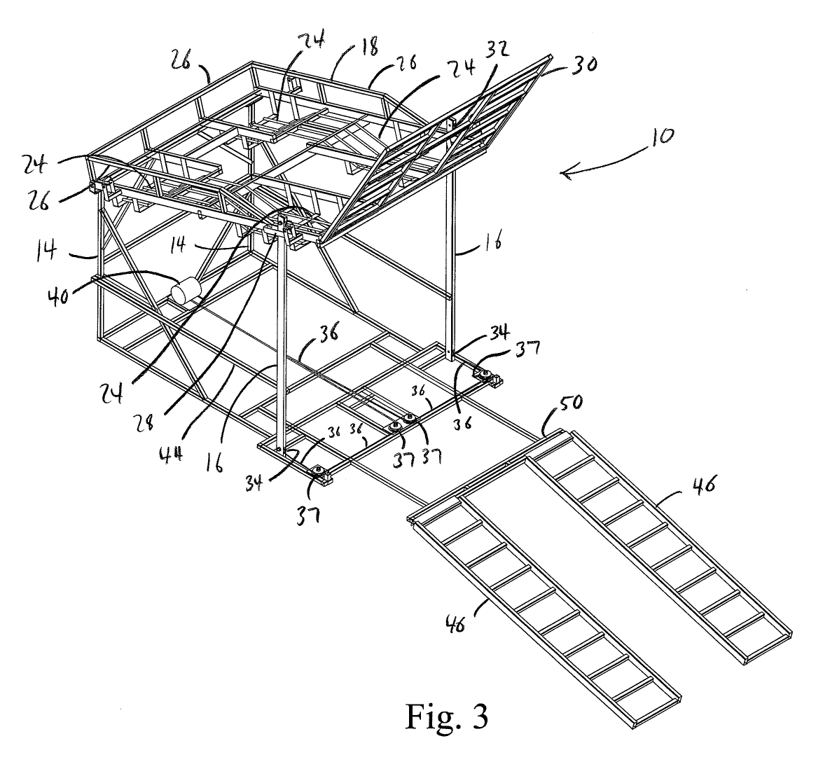

Next, referring to FIG. 3, the winch 40 is operated to pivotally lower the platform 18 about its attachment points to the front uprights 14. This is accomplished by the winch 40 drawing out the cable 36 which extends about the upper pulley 32 and attaches to the platform 18. The platform 18, at its lowest position, rests upon a side frame support 44 and is at an inclined position. The ramp 30 further rotates about its attachment to the platform 18 and extends over the lowered truck tailgate. Ramp extensions 46 are attached to the ramp 30 and lengthen the ramp 30 to the ground. An ATV may be driven up the ramp 30 and onto the platform 18. Furthermore, an extendable ramp extension support 50 is extendable from a first position in FIG. 1 to an extended position in FIGS. 2 and 3 to support the ramp extensions 46 and prevent scratching of the paint of the truck tailgate.

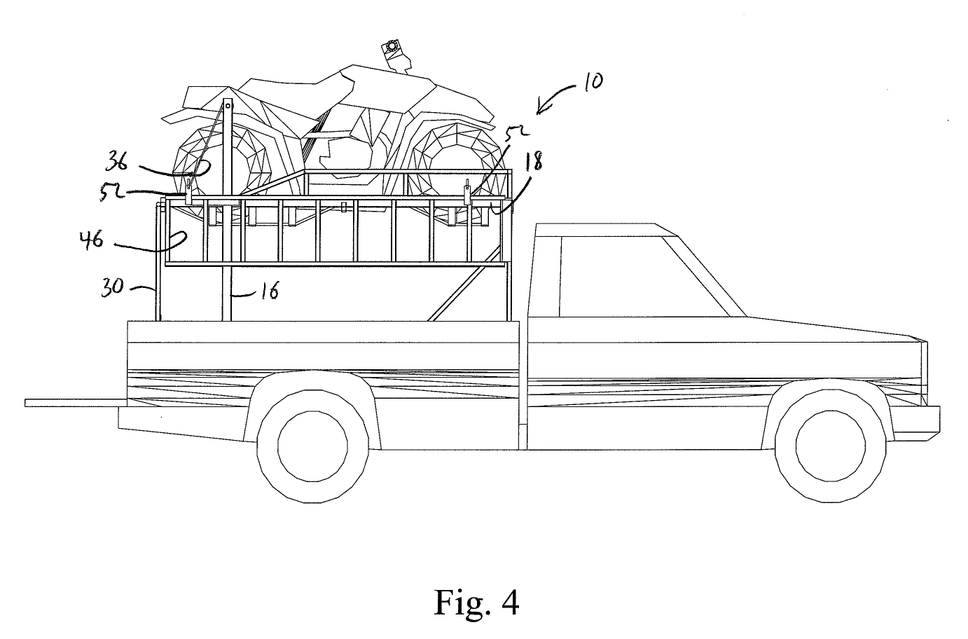

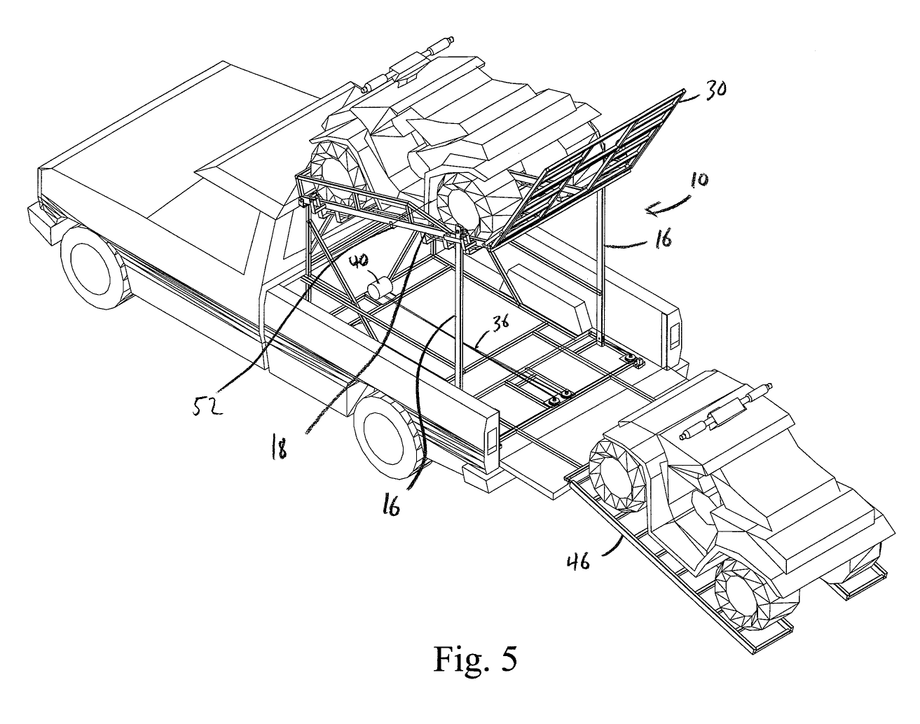

Referring to FIG. 4, the apparatus is placed within a truck bed and operated to the position shown in FIG. 2. Next, an ATV is driven up the ramp extensions 46 and ramp 30 and onto the platform 18. Referring now to FIG. 5, the winch 40 is operated to draw in the cable 36 to raise the platform 18 to the top of its travel along the rear uprights 16. This is accomplished by the winch 40 drawing in the cable 36 which extends about the upper pulley 32. The ramp 30 is also raised and maintained in an upward position by a bracket 48 to provide access to the area below the platform. At this point, a second ATV may be driven up the tailgate ramps 46 onto the bed of the truck which rest upon the tailgate ramp extension.

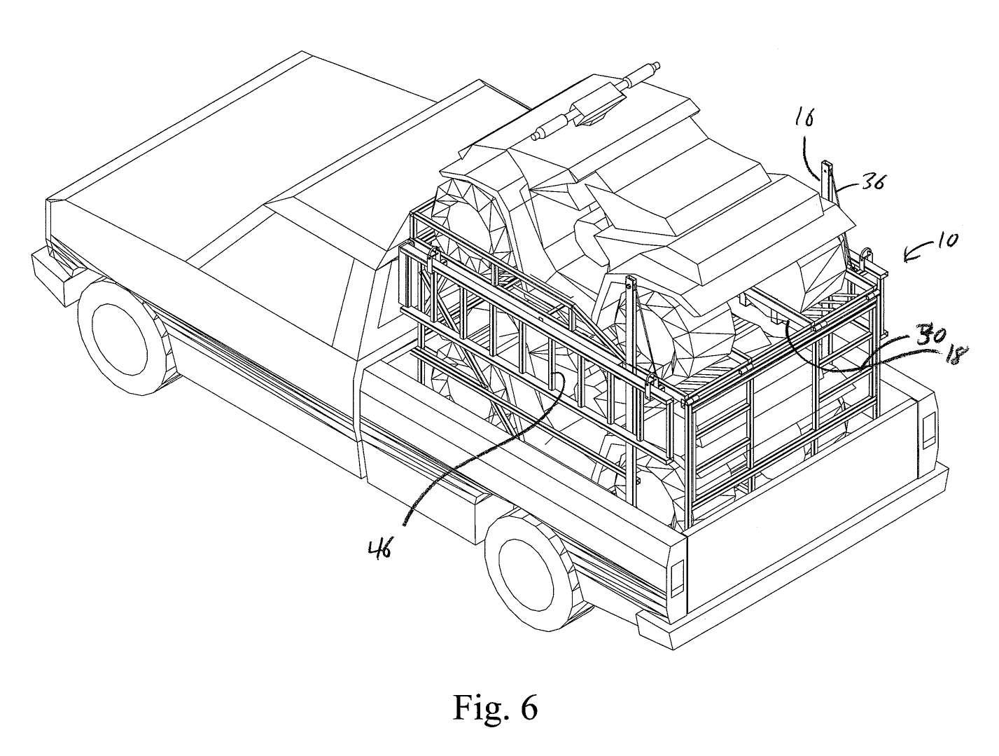

Finally, referring to FIG. 6, the platform 18 is lowered to the horizontal position and pins 42 are inserted through the mounting blocks 28 and the rear uprights 16 to maintain the platform 18 in the horizontal position.

To unload the ATVs the process is reversed.

As discussed above, an extendable and retractable ramp mount 50 may be implemented. The ramp mount 50 forms a base upon which the ramp extension 46 may be placed in order to prevent damage to a truck tailgate, when extended. When not in use, the ramp mount 50 may be moved to a retracted position whereby the tailgate of the truck maybe closed.

Moreover, referring to FIGS. 1, 4 and 6, the extension ramps 46 may be hung from hooks 52 when not in use.

While the specific embodiments have been illustrated and described, numerous modifications come to mind without significantly departing from the spirit of the invention, and the scope of protection is only limited by the scope of the accompanying claims.

I claim:

1. An apparatus for transporting multiple off-highway vehicles in a bed of a pickup truck comprising:
a pair of front uprights;
a pair of rear uprights;
a platform pivotally attached to the front uprights and slidingly attached to the rear uprights; and
a cable for pivotally raising and lowering the platform about its attachment to the front uprights, such that a first ATV may be parked on the platform and a second ATV may be parked under the platform so that the pickup truck may transport two ATVs simultaneously.

2. The apparatus of claim 1 wherein the cable extends about a first pulley located at the top of the rear uprights.

3. The apparatus of claim 2 wherein the cable extends about a second pulley located at the bottom of the rear uprights.

4. The apparatus of claim 2 wherein the rear uprights are hollow and the cable extends through rear uprights.

5. The apparatus of claim 1 wherein the platform defines four recessed areas generally corresponding to locations where the four wheels of an ATV are located.

6. The apparatus of claim 1 wherein the platform comprises two mounting blocks that are located about the rear uprights to provide lateral support for the platform.

7. An apparatus for transporting multiple off-highway vehicles in a bed of a pickup truck comprising:
a pair of front uprights;
a pair of rear uprights;
a platform pivotally attached to the front uprights and slidingly attached to the rear uprights;
a ramp pivotally attached to a rear edge of the platform; and
a cable for pivotally raising and lowering the platform about its attachment to the front uprights, such that a first ATV may be parked on the platform and a second ATV may be parked under the platform so that the pickup truck may transport two ATVs simultaneously.

8. The apparatus of claim 7 wherein the cable extends about a first pulley located at the top of the rear uprights.

9. The apparatus of claim 8 wherein the cable extends about a second pulley located at the bottom of the rear uprights.

10. The apparatus of claim 8 wherein the rear uprights are hollow and the cable extends through rear uprights.

11. The apparatus of claim 7 wherein the platform defines four recessed areas generally corresponding to locations where the four wheels of an ATV are located.

12. The apparatus of claim 7 wherein the platform comprises two mounting blocks that are located about the rear uprights to provide lateral support for the platform.

13. An apparatus for transporting multiple off-highway vehicles in a bed of a pickup truck comprising:
a pair of front uprights;
a pair of rear uprights having a top pulley generally adjacent an end thereof and a bottom pulley generally adjacent an end thereof;
a platform pivotally attached to the front uprights and slidingly attached to the rear uprights;
a ramp pivotally attached to a rear edge of the platform;
a cable for pivotally raising and lowering the platform about its attachment to the front uprights, such that a first ATV may be parked on the platform and a second ATV may be parked under the platform so that the pickup truck may transport two ATVs simultaneously.

14. The apparatus of claim 13 wherein the rear uprights are hollow and the cable extends through rear uprights.

15. The apparatus of claim 13 wherein the platform defines four recessed areas generally corresponding to locations where the four wheels of an ATV are located.

16. The apparatus of claim 13 wherein the platform comprises two mounting blocks that are located about the rear uprights to provide lateral support for the platform.
